(19) United States
(12) Patent Application Publication
(10) Pub. No.: US 2023/0130945 A1
(43) Pub. Date: Apr. 27, 2023

(54) SECURE SHIPMENT CONTAINER AND RELATED METHODS

(71) Applicant: Jorge Sanchez-Olea, Poway, CA (US)

(72) Inventor: Jorge Sanchez-Olea, Poway, CA (US)

(21) Appl. No.: 17/968,394

(22) Filed: Oct. 18, 2022

Related U.S. Application Data
(63) Continuation of application No. PCT/US2022/046896, filed on Oct. 17, 2022.
(60) Provisional application No. 63/256,667, filed on Oct. 18, 2021.

(51) Int. Cl. B65D 55/02; B65D 65/40; B65D 59/06; B65B 5/04; B65B 7/28; B65D 59/04

(52) U.S. Cl. CPC B65D 55/028; B65B 5/04; B65B 7/28; B65D 59/04; B65D 59/06; B65D 65/40

(57) ABSTRACT

An apparatus and method for secure shipment of goods monitors location and status with multiple sensors embedded in the package of the shipment container. Encryption methods help ensure the shipped goods are authentic, and that the goods were not tampered with during shipment. Information placed in an RFID tag may provide the user with the history of performance during transit to ensure the quality of the goods from the shipment site to the receiving site.

### RELATED APPLICATIONS

This application is a continuation of PCT Application Serial Number PCT/US2022/ filed on Oct. 17, 2022 and also claims priority to U.S. Provisional Application Serial Number 63/256,667, filed on Oct. 18, 2021, entitled Secure Shipment Container With Continuous Monitoring Using Sensors And Communication Channels. The entire disclosures of all the related applications set forth in this section are hereby incorporated by reference in their entireties.

### BACKGROUND

Shipping containers used in transportation of goods are vulnerable to a multiplicity of problems. A common problem is the intrusion into the container to replace the goods shipped for less valuable goods and counterfeits. Other issues exist when the goods shipped can exhibit sensitivity to extreme temperatures which can make the goods spoil and degrade. It is possible to breach a shipping package through the walls of the container, which causes a breakdown of the shipment quality and places doubts on the authenticity of the shipped goods. Some goods like pharmaceuticals have an expiration date for the medications, and to be effective, there needs to be a time stamp somewhere on the package. Other goods have a high monetary value such as jewelry, perfumes, wine, clothing. Critical legal documents are also shipped through the mail system which need to be protected. Art items such as paintings and sculptures need to be shipped securely, on time and without exposure to extreme ambient conditions. Counterfeit products for critical electronics, if they enter the military supply chain can cause loss of life and jeopardize national security.

There are solutions that include the utilization of Radio Frequency Identification (RFID) tags. These tags are useful for tracking materials during shipment, but they only track the shipment and not protect the authenticity or monitor environmental conditions that can affect the articles in a shipment. The presently used RFID tags will not always monitor the shipment and will not by itself include sensors to determine if environmental conditions are such that the goods can be damaged in transit.

There have been proposed solutions that include attaching a set of conductors inside of packages to form an antenna which can respond to an external radio frequency monitoring receiver used to verify the antenna is intact inside of the container. Presumably this configuration will ensure the items inside a shipping container will be secured from tampering and will also maintain quality. This approach is not practical since it is not possible to have frequency monitoring receivers at all locations where the monitors can actively continuously check the shipping package throughout the geographical travel of the goods. There is also no way to protect all the internal surfaces of the package from intrusion by placing dense conductors while still forming an effective radio antenna. Furthermore, with this approach, RF antennas must be individually placed and tuned for each type of package and tuned to a nearby monitoring receiver frequency. This approach makes the proposed solution costly and not practical for industry to be used as a solution to monitor and protect the health and authenticity of the shipped goods.

It should be noted that this Background is not intended to be an aid in determining the scope of the claimed subject matter nor be viewed as limiting the claimed subject matter to implementations that solve any or all of the disadvantages or problems presented above. The discussion of any technology, documents, or references in this Background section should not be interpreted as an admission that the material described is prior art to any of the subject matter claimed herein.

### SUMMARY

In one implementation, a shipping container comprises a container body comprising one or more layers, at least one sensor embedded within at least one of the one or more layers or positioned between at least two of the one or more layers, and monitoring electronics connected to the sensor, wherein the monitoring electronics is configured to detect a tampering status of the container based at least in part on a signal from the sensor. The monitoring electronics may comprise one or more additional sensors. The sensor embedded in the layers may comprise a conductive material such as wire or conductive ink. At least a first portion of the embedded sensor may be positioned between two layers of paperboard.

In another implementation, a method for securing a shipping container comprises placing goods into the container and placing a removable cap onto the container. In this implementation, the placing connects monitoring electronics embedded in the cap with at least one sensor embedded in the container.

In another implementation, a shipping container comprises a container body and a removable container cap. The container body comprises a container wall comprising at least one sensor, the container cap comprises monitoring electronics, and the monitoring electronics are coupled to the at least one sensor when the container cap is coupled to the container body.

In any of the above implementations, the container may be in the shape of a tube, a bag, or a box.

It is understood that various configurations of the subject technology will become apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

### BRIEF DESCRIPTION OF THE DRAWINGS

Various embodiments are discussed in detail in conjunction with the Figures described below, with an emphasis on highlighting the advantageous features. These embodiments are for illustrative purposes only and any scale that may be illustrated therein does not limit the scope of the technology disclosed. These drawings include the following figures, in which like numerals indicate like parts.

FIG. 1a shows a typical shipment container implemented using a paper tube.

FIG. 1b shows a typical shipment container implemented as a square box showing detail of the opening flaps for the box.

FIG. 2a shows a shipping container with conductive wire placed around the periphery of the container to be used as an intrusion sensor.

FIG. 2b shows the shipping container after the paper layer has been added to the tube, a plug has been inserted at the bottom and the position of a cap to be placed on the top of the container.

FIG. 3a shows details of the top side cap used to close the container after placing the goods to be shipped inside the tube.

FIG. 3b is the plug placed on the top side cap for the shipping tube container

FIG. 4 shows the completed shipping container after it is completed with an overlay of paper to embed the wiring, after the goods have been placed inside and the cover has been closed

FIG. 5 is a block diagram of the control electronics with additional sensors used to monitor status of the shipment

FIG. 6 shows the monitoring process for the shipping container used to inform and continuously monitor the progress of the shipment and the status of the sensors.

FIG. 7 shows the control and monitoring process for a client server configuration used to remotely monitor the shipment on a continuous basis.

FIG. 8 is an alternative configuration for a shipping container.

FIG. 9a is an alternative configuration for a shipping container in the form of a box.

FIG. 9b shows a tampering sensor and monitoring electronics to a shipping container in the form of a box.

### DETAILED DESCRIPTION

The following description and examples illustrate some exemplary implementations, embodiments, and arrangements of the disclosed invention in detail. Those of skill in the art will recognize that there are numerous variations and modifications of this invention that are encompassed by its scope. Accordingly, the description of a certain example embodiment should not be deemed to limit the scope of the present invention.

Implementations of the technology described herein are directed generally to apparatus and methods used to monitor shipment containers with the use of sensors to better ensure they are protected and monitored from door to door in the shipment process. Monitoring sensors may include one or more of temperature, pressure, motion, intrusion, and means for counterfeit part detection. Containers described herein are commonly used for shipment of documents, paintings or other works of art, legal documents, consumer merchandise, mechanical parts, and electronic parts. These types of containers are extensively used by leading companies to send shipments.

The disclosed apparatus and methods may use sensors to protect the shipped goods by including various sensors in the shipping package, a set of electronic monitors that protect the shipped goods from door to door, communication technologies for communicating with monitoring facilities, and verification methods for the end user to verify the goods shipped to them meet expectations of authenticity and quality.

Embodiments disclosed herein address the above-stated needs to protect shipped goods to consumers and other industries from damage due to environmental conditions and from replacement with low quality substitutes, or counterfeits.

Embodiments of the present technology may include an arrangement of a protection layer and a set of sensors to help ensure the shipped goods are safe, authentic, and not damaged, and the protection is done on a continuous basis during shipment and travel over different geographical locations using sensors, processors for electronic monitoring and means of communication. Sensors that can be embedded in the shipping package including wire, optical fiber, or conductive ink made of various chemical mixtures that can include carbon, silver and other materials as needed for the specific application. In addition, other materials such as partially conductive material, thin conductive film, semiconductors, an assortment of pressure temperature, friction, capacitance, humidity, optical and any other sensors can be included as needed to monitor the security, quality, and environmental stress sensitivity.

In addition, certain embodiments can use location methods to determine GPS coordinates and can integrate any of the available set of communication interfaces such as Wi-Fi, RFID, Bluetooth, and Cellular to continuously report status to a remote monitoring service using the Mobile communications (cell) infrastructure. Communication for monitoring purposes can be automatically done to security personnel nearby using Bluetooth, Wi-Fi, or RFID.

The RFID capability can also be used as the means for embedding security, serial numbers, source, destination, tracking, and sensor information in the shipping package to be used for later review.

In applications where tampering protection is necessary, the tampering sensor can be implemented with a pattern of embedded wire in such a way that the cutting of the wire is detected by a processor and interpreted as an attempt to enter the container and have access to the goods targeted for shipment. The wire can be of fine gauge so that it can be disguised within the package and can be placed as dense as it is needed to prevent intrusion. Also, wire can be placed in a mesh configuration with a density high enough to prevent access.

Security and authentication to prevent forgery of the container itself or the goods inside can be obtained with the use of encrypted communications, and the addition of a token or a pedigree at the point of shipment. Also, it is possible to include an internal pedigree in the container in this invention by using physical parameters measured by the sensors, or data from random number generators, or a digitized analog component signature with unique characteristics.

A significant challenge in shipping containers for consumer use is cost and environmental concerns. Typical shipping containers use paper, paperboard, cardboard, and the like which are inexpensive and biodegradable. To implement one or more of the functions previously described, implementations of the inventive principles described herein may embed in those types of inexpensive materials the sensors as well as all the needed functionalities with the appropriate manufacturing techniques. These techniques can be implemented with assembly tooling ranging from simple hand tools, and with various degrees of highly automated machinery.

The manufacturing implementation can be done using circuits, batteries, electronic components printed directly on the substrate used, which can be made of plastics or other convenient substrate as needed to achieve the cost effectiveness of mass production for high volumes. The physical look of the protected container in this invention can be a shipment packaging material where the sensors are embedded in the material in a way that the sensors surround the goods to be shipped. It is anticipated that the solution can be applied to shipping palleted containers by using the appropriate scaling measures with the sensors.

In order to achieve the constant monitoring, the container described in the preceding discussion may use one or more various technical features. A processor embedded in the shipping container may store the status of the sensors with a time stamp to record all the information in processor memory. The information can then be sent to anexternal device such as an RFID reader, or to another system using Wi-Fi , or to a mobile phone or another Bluetooth-enabled device. If the objective in each shipment application is to obtain real-time location, then a GPS unit can be used in conjunction with the shipment container to report status of the sensors. If the needs are to send the monitoring information to a remote location, then either a near Wi-Fi portal can be used or Cell communications.

For a remote monitoring secure application, the method can be for the container to send a data package with the sensor information to a server in a cloud installation using cable after a Wi-Fi portal connection. If the means of communication to a server is the use of Cell, then the wireless cell communication channel can be used.

For applications where the receiver of the shipment also needs to be notified, appropriate access to the receiver of the goods can be provided.

The disclosed embodiments provide systems, devices, and processes for tamper evident security of a shipping container. Included is an apparatus containing an Electrical pattern used as a sensor for tampering, environmental sensors, geolocation and communication features, and a process consisting of a sensor test, security features, communication systems, geolocation, and security system. All these features allow a shipping container to be protected from intrusion on all its sides, to collect environmental information during shipment and to be monitored remotely.

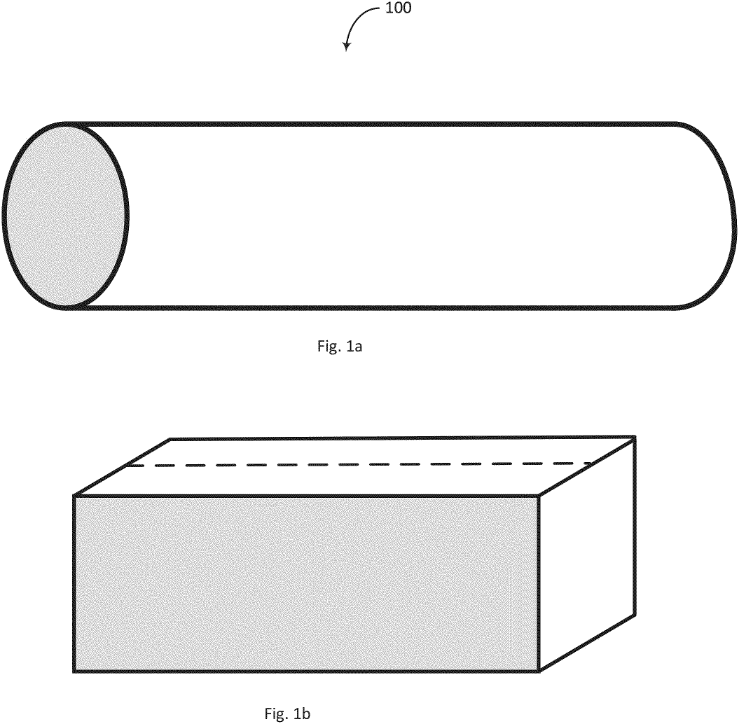

FIG. 1a, 100 illustrates an example of a shipping container made in the form of a tube. FIG. 1b shows a shipping container made in the shape of a box. Both containers are commonly used for shipping articles, and it is our objective to protect and monitor these types of containers for potentially harmful environmental conditions, from unwanted intrusion, and to be able to be monitored during shipment. The shipping containers may be formed from paper, paperboard, or cardboard having one or more layers. Multiple layer shipping containers may include one or more flat and one or more fluted layers. Tamper sensors such as described below may be placed, deposited, and/or positioned on or against internal surfaces of flat or fluted layers of such containers so that the sensor material is not visible from outside the container. In some implementations, a single layer of paper may be manufactured with tamper sensor material as described herein embedded inside the single layer. In some implementations, at least some of the sensor material can be made visible on an outer surface of the container.

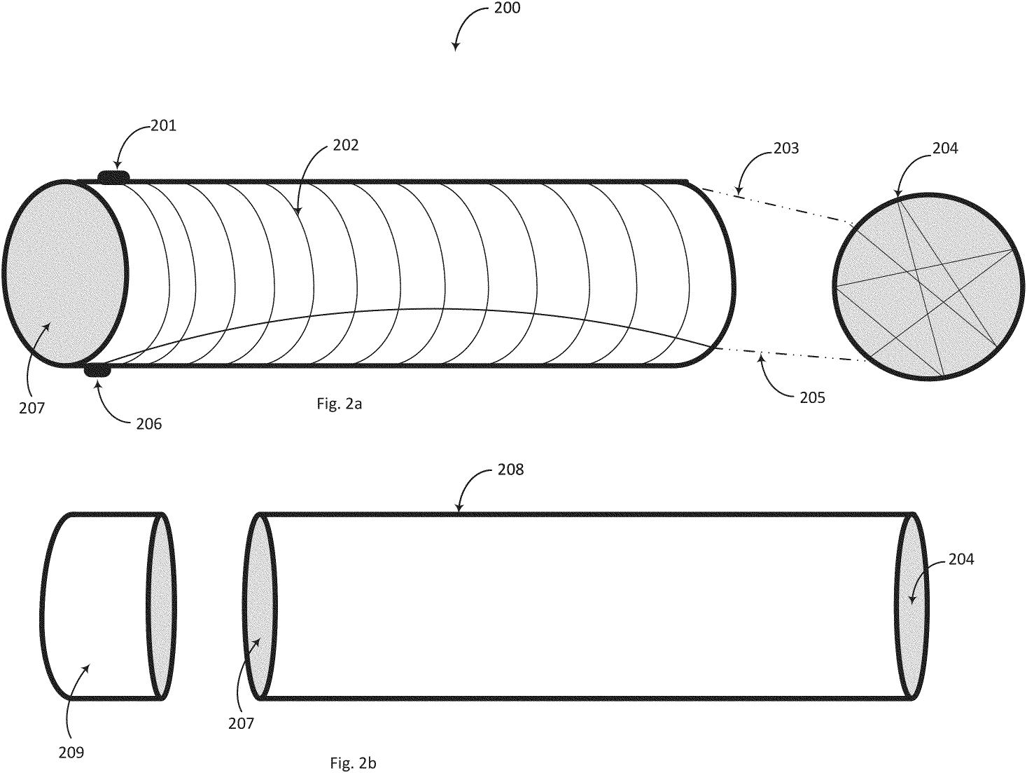

FIGS. 2a and 2b at 200 show several construction features for a secured container in accordance with some implementations of the invention. FIG. 2a shows a tubular container 100 with an opening on the top 207 and a bottom plug 204. To install wire used as a sensor, a fine gauge wire may be connected at an electrical contact point 201, then the wire is wound around the tube 100 as shown in 202. When the bottom of the tube is reached, the wire may continue at 203 to the bottom plug 204 where it may be routed in a pattern to cover several sections of the bottom plug. Next at 205 the wire may exit the bottom of the tube and be routed to the electrical contact at the top of the tube at 206.

FIG. 2b illustrates the next step in the construction of the container. The tube with wire in FIG. 2a may be covered with one or more outer layers of paper to embed the wire on the tube in a way that the wire cannot be seen as shown in 208. The bottom plug 204 has also been covered in paper to hide the wire routed on the bottom plug. FIG. 2b also shows the cap 209 that is used to seal the container once the shipping goods have been placed inside the completed tube 208.

After achieving the placement of wire 202, placing a cover on the wire 208 and installing the cap 209, as shown in FIG. 2b, then the tube has been covered with the wire which is to be used as a sensor and the wire has been embedded. For the purposes of shipping material goods, the goods to be shipped are placed into the tube through the opening at 207 and thereafter the shipping tube is sealed by inserting the cap 209 on top of the tube 208. In some implementations, a conductive liquid (e.g. conductive ink) can be sprayed or otherwise deposited onto a layer of the container to form the tamper sensor. This can be a cost effective material and can allow relatively wide strips of conductive material to be applied to the container.

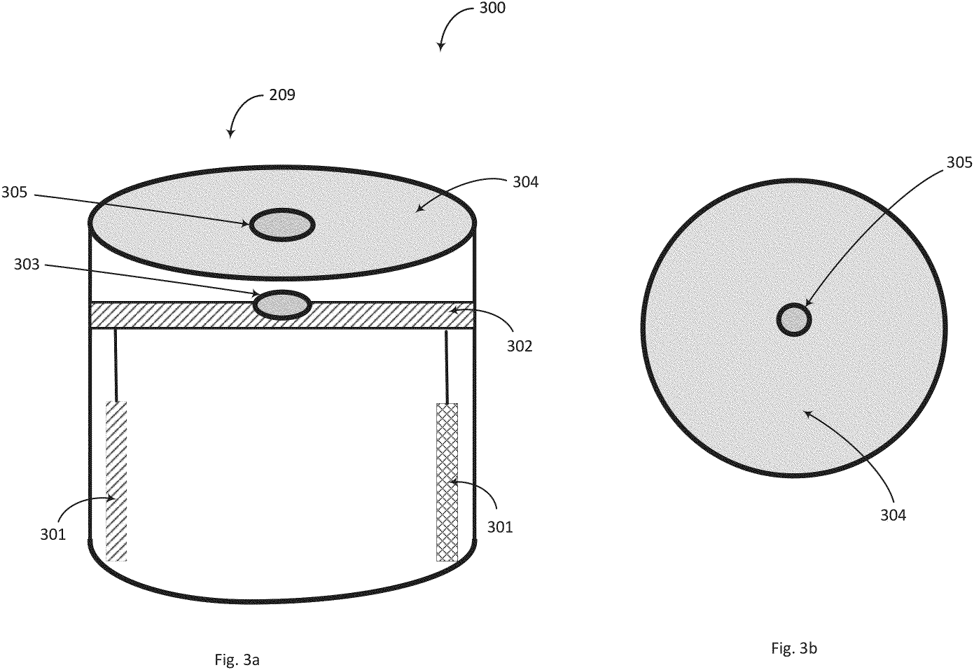

FIG. 3, 300 illustrates construction details of the cap 209 used to seal the container once the goods to be shipped have been placed in the tube 208.

FIG. 3a demonstrates several technical features of the cap 209. The cap 209 contains features needed to seal the container, implement sensors, monitoring and communication features. At 301, electrical contacts on the cap 209 are used to connect the cap 209 to the electrical contacts 201 and 206. When the cap 206 is placed on the tube 208, it is possible to established electrical continuity throughout the shipping container. Electronics monitoring unit 302 is used to verify electrical continuity throughout the container. The electronics monitoring unit 302 will detect intrusion if the wiring is cut. The electronics monitoring unit may also contain one or more environmental and/or motion sensors, a geolocation unit, and communications units. If at any time during the shipment the container is violated by breaking the wire, or if any of the sensors exceed predetermined thresholds, then the electronics monitoring unit 302 will sense the intrusion, the value of the sensors, record the intrusion and the time stamp of when the any of the events , intrusion, or sensors out of value occurred. In addition, the electronics monitoring unit can also communicate to a remote monitoring center its geolocation using any of the available communication channels. In addition, the electronics monitoring unit 209 can also blink a red LED 305 to indicate monitoring conditions, tampering or sensors have been exceeded. Monitoring information is also saved in an RFID contained in the electronics monitoring unit 209. FIG. 3b is a top view of the plug 304 used with the cap 209. It is placed above the entire cap 209 to protect the electronics monitoring unit 302. The plug 304 can include a monitoring port 305 used to display the LED indicating the status of the shipping container.

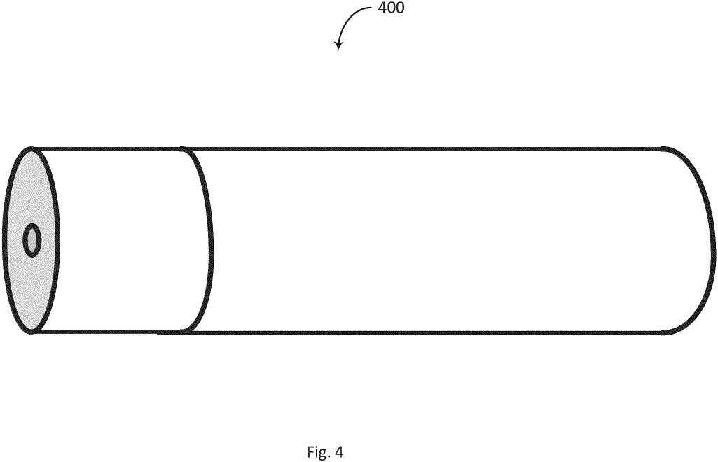

FIG. 4, 400 shows the completed shipping container after the cap 209 has been placed and the container is ready to be shipped. Once the cap 209 is placed, the electronic monitoring unit is activated, and the shipping container is ready for shipment.

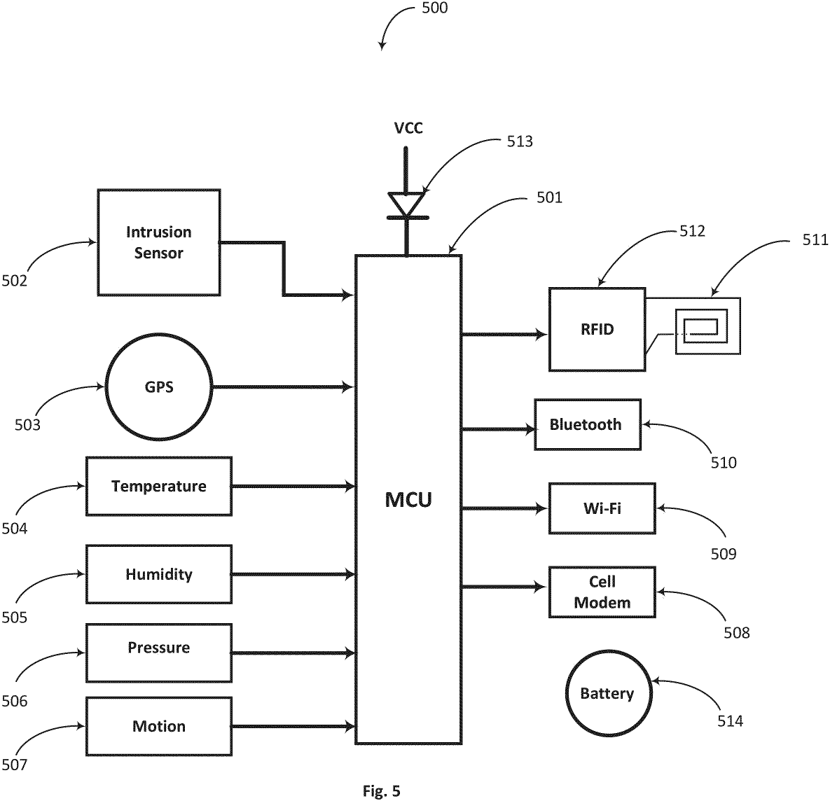

FIG. 5, 500 shows the elements of the electronics unit monitoring unit 302, containing sensors, communication and geolocation features and a display function. At 501, the unit includes a Microcontroller Unit (MCU) with the necessary firmware to manage the operation of the electronic system. The MCU can also be implemented with programmable logic or with application specific integrated circuits.

The MCU 501 can store information regarding thresholds for various sensors which are acceptable during the shipment of the container. At 502 the diagram in FIG. 5 shows the intrusion sensor. In the embodiment of the container in FIG. 4 the sensor is a wire placed around the periphery of the tube. In other alternative embodiments, the intrusion sensor can be implemented with a suitable arrangement of capacitive sensors placed around the periphery of the container, if there is any disruption of the container the capacitive sensors will sense the change in capacitance and the change will be then detected by the MCU 501. Other intrusion sensors can be implemented with conductive ink printed on the surface of the tube, semiconductor material, or fiber optic glass or plastic fibers. In this embodiment, the wire used as an intrusion sensor will detect intrusion or tampering if it is open or if it was cut during shipment. Another way to detect intrusion into a container is to use reflection properties of the wire. For example, at the shipping location, the electronic monitoring unit 302 can include a pulse generator and a timer in a configuration known as a time domain reflectometer (TDR). At the shipping location, using a pulse generator a pulse is sent while an electronic timer is started. Any discontinuities along the length of the wire will cause reflections of the pulse. The as the reflected pulses return to the pulse generator, the reflected pulses are detected while the timer records the time when any reflected pulses returned. This information is recorded to be used as an initial signature. If the wire is cut and then soldered again during shipment, the reflection properties will change. At the receiving location, the MCU 501 can repeat the test using time domain reflectometer. A solder joint will reflect the pulse and send it coming back to the pulse generator. Thus, the change in reflection will produce a different signature from the signature at the shipping location which can be an indication the reflection properties of the cable changed, which in turn will be an indication or tampering during shipment. The electronic monitoring unit can run a wire continuity test periodically during shipment to continuously monitor the container. At 503 a Global Positioning unit can be placed in the electronics unit to be able to monitor the GPS location of the shipment package and especially during shipment. There are applications where the goods to be shipped require certain environmental conditions to maintain the quality of the goods shipped. For example, shipping seafood requires a certain temperature range to maintain quality. Another example is the temperature control for the shipment of vaccines. Yet another example is the controlled humidity of works of art where humidity could alter a painting. For these purposes, our electronic monitoring unit contains temperature sensor 504, humidity sensor 505 and pressure sensor 506. If we ship fragile material, it is necessary to minimize shock, vibration, and movement. These parameters can be obtained from the motion sensor 507 and with some signal processing in the firmware embedded in the microcontroller 501.

The electronic monitoring unit 500 can include a set of various types of communication elements. These elements can be a cell modem 508, which can be used to establish a remote connection to a monitoring center to report the location and status of the shipment. Cell modem communications can be for example 4G LTE CAT M or 2G GSM, or 5G communications. In addition, short range communication can be established in a fixed location with the use of a Wi-Fi modem 509. In some applications it can be convenient to have a Bluetooth 510 module to send information to a receiving Bluetooth unit in a mobile phone. RFID read and write tag 512 and antenna 511 can be used to provide information to a reader and can be used to receive tracking information regarding the shipment in each location such as a delivery truck or a shipping distribution center. The RFID tag 512 can contain a file that summarizes the values of the sensors during the travel of the shipping package. The RFID tag can contain customized values for the thresholds of the sensors which are entered at the shipment location. In addition, the RFID can store a password, token, encryption key, and a pedigree serial number to meet Cybersecurity and authentication goals. The file in the RFID tag can be read with an RFID reader and a phone app by the person receiving the shipment to determine if the goods were not damaged or tampered with. One or more of these communication devices can be used in the electronic monitoring unit 501 as needed for a given application. The electronic monitoring unit 500 also includes one or more LED indicators 513, which can be seen through the port 305, and which are used to signal the person receiving the shipment if any of the sensors exceeded thresholds. For example, the LED can flash red if the shipment container was tampered with or if any sensors exceeded threshold. Alternatively, the LED can flash green if there was no tampering during shipment, or alternatively can turn on an amber color LED to signal the package is not yet sealed. Finally, since the shipment container is a portable device, we include a battery 513 with the electronic monitoring unit 500.

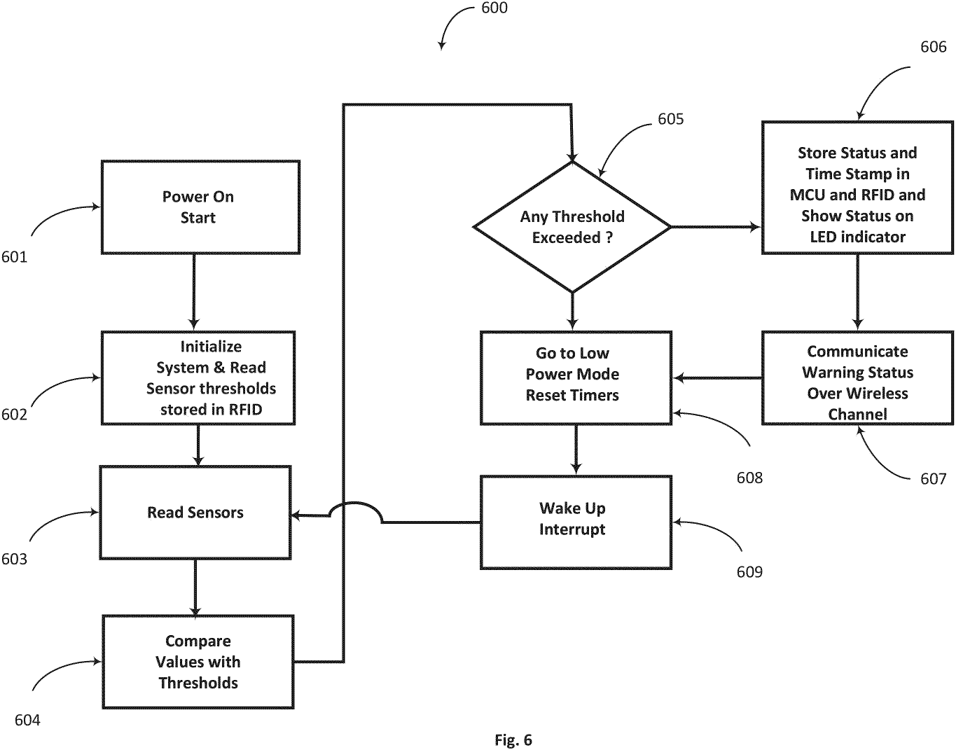

FIG. 6, 600 illustrates a possible monitoring process algorithm used to secure the shipment and maintain the quality of the goods in the shipping container. At 601, the process starts when the unit is powered on. Shipping containers are typically battery operated so the power on is initiated by pulling a strip of insulating plastic from one of the ends of the battery 514 or by a circuit closure of the cap 209 with the rest of the container 208. Once the power is connected, the MCU 501 will initialize the system variables and will read the thresholds of acceptable values for the sensors from memory in the MCU 501 corresponding to customized values stored by the user at the shipping location in the RFID 512. The next step 603 is to read and digitize the values of the sensors at the present time. As shown in step 604, the values of the sensors at the present time are compared with the threshold values read in step 602. In step 605 the MCU 501 decides, if a threshold is exceeded, then the MCU 501 goes to step 606 where it stores the status that shows the threshold exceeding values and a time stamp of when this occurred. This information is stored in the flash memory of the MCU 501, and the information is also stored in the RFID 512 memory. The time stamp is necessary to understand the time when any issue with the shipment has occurred so that preventive measures can be taken in the future. In the case of a high-end system, the next step at 607 is to use one of the communication channels such as Wi-Fi 509 and or a cell modem 508 to pass on to a monitoring center the information containing the problem with the shipment. If there are no remote communication channels available, then we simply follow the process to step 608 where the MCU 501 goes into low power mode to preserve battery power. If the thresholds were not exceeded at 605, the MCU 501 also goes into low power mode at 608 and there may not be a need to store status variables and communicate to a monitoring center unless the MCU 501 was programmed to do so regardless of sensor status. In step 608, timers are reset to prepare the system for the next point in time when the MCU 501 needs to wake up from its low power mode of operation. In step 609, the internal timer wakes up the MCU 501 and the firmware returns to step 603 when the sensors are read again, and the remainder of the processing loop is executed. The period of when the MCU501 is woken up from low power mode is programmable in the initialization process and can be customized by entering timing values in the RFID tag 510. The same is done for the thresholds of acceptable range of the sensors. The process starting from step 603 to the completion of the steps 604 to 609 are repeated periodically to monitor the container for the duration of the shipment.

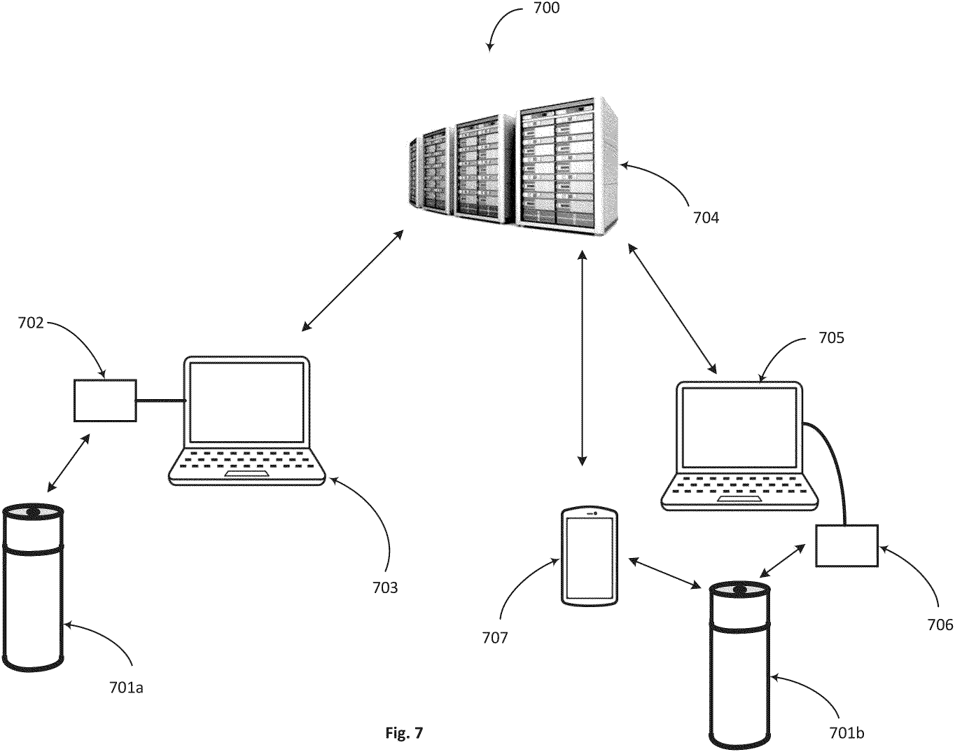

FIG. 7, 700 illustrates the communication system used for monitoring the shipment of the container with the secured goods. A container is shown at 701a after the shipping goods have been stored in the unit and the cap has been used to seal the container. This is the point of shipping and uses a computer terminal or a PC 703 to prepare the container for shipment. Software in a Terminal or PC, 703 uses an RFID reader/writer 702 to send an encryption security key to the RFID tag 510. The encryption key will in turn will also be stored in the MCU 501. In addition, a pedigree message, serial number, sensor thresholds, destination information and other instructions that are unique to the container and the shipment of the specific goods can also be stored by the PC 703 into the RFID 512 inside the container 701a. All this information is also stored in the MCU 501. The electronics monitoring unit 502 uses the security key to control access into the electronics monitoring system software. and the pedigree is used to authenticate the specific shipping container 701a. The PC 703 will in turn send information to a remote server 704. Information will include items such as the contents, the encryption key, email, and name of person at the receiving end of the shipment, source address, geographical destination and other shipping managing information. The server 704 will typically be used to manage and monitor the shipment process.

As part of the shipping process, the server 704 will in turn send a message with information to the recipient’s mobile phone 707 or the recipients PC 705. This information can be a URL link needed to reach the server to obtain the encryption key, serial number0 of the package shipped and other related shipment information. The recipient will then use the PC 705 and the RFID reader 706, or a Mobile phone 707 to connect with the received shipping container 701b. The PC 705 with the RFID reader 706 or the cell phone 707 will then connect with the RFID tag 512 of the container. The container RFID tag 512 will only respond to the tag reader 706 or the cell phone 707 reader if the reader sends the encryption key. If the encryption key is provided, then the container 701b will relay information about the shipment such as status of the environmental sensors, and if the container was ever opened during transport from the shipping source.

Alternatively, if the recipient of the shipment does not have computing capabilities, they can look over the porthole 305 on the top of the container to determine if any sensor thresholds were exceeded or if the container was tampered with during shipment. As described before, a green LED means good shipment, a red LED means either tampering or sensors exceeded threshold.

Various modifications to these embodiments, and the generic principles defined herein may be applied to other embodiments without departing from the spirit or scope of the present technology. Thus, the present technology is not intended to be limited to the embodiments shown herein but is to be accorded the widest scope consistent with the principles and novel features disclosed herein.

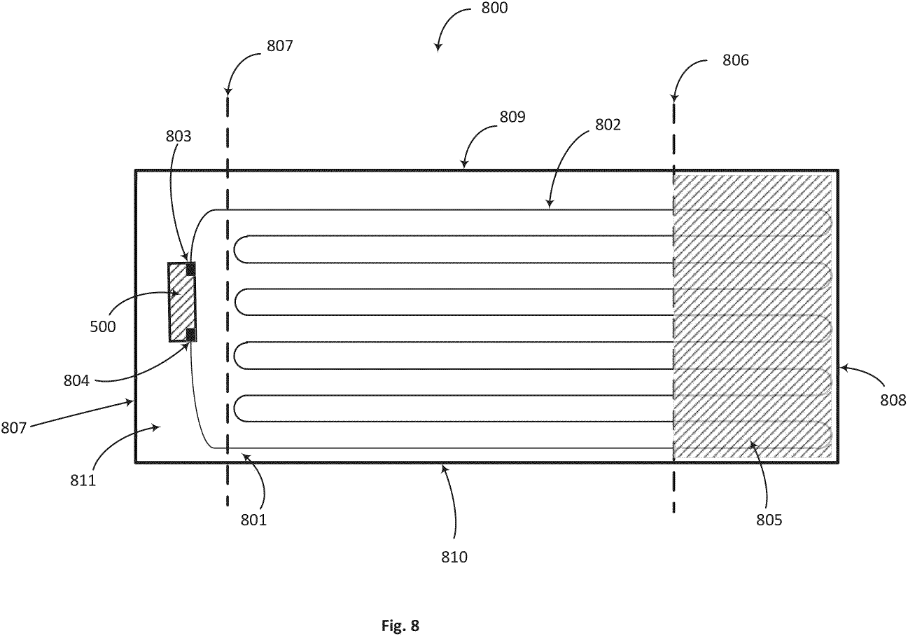

For example, FIG. 8, 800 shows an alternative package that includes the sensor and security features previously presented. The alternative configuration consists of a base material shown at 801 which can be paper-based or plastics. On top of the base material a continuous pattern with wire 802 is laid out from point 803 where it connects to the electronic monitoring unit 500 throughout the base material and returns to point 804 where it connects again to the electronics monitoring unit 500. This wire is used as a sensor to detect intrusion if the wire is ever cut. A second layer of the similar material 805 can be placed on top of the wire. The diagram illustrates a portion of the second layer; however, this second layer or material can extend from point 806 to point 807. This step accomplishes the goal of embedding the wire in the structure. The goods to be shipped can be placed on top of the second layer of material 805. The electronics monitoring unit 500 is connected to the beginning of the wire at 803 and 804 respectively. Thereafter, the package can be closed by rolling over the assembly from the right side 808 towards side 807 in a circular fashion. The product is then made into a roll. Alternatively, side 808 can be folded over so the entire container is divided in half to reach location 807. In these options, the sides of the container should be sealed of glued on sides 809 and 810 to prevent intrusion from the sides. After securing sides 809 and 810, a small opening on side 807 can be left to place the goods prior to shipment. The strip in section 811 containing the electronics monitoring unit 500, can be covered with tape with adhesive on one side so that after the goods are placed in the container, then the flap 811 can be folded in a way that flap 811 will be glued to the rest of the container to seal the opening.

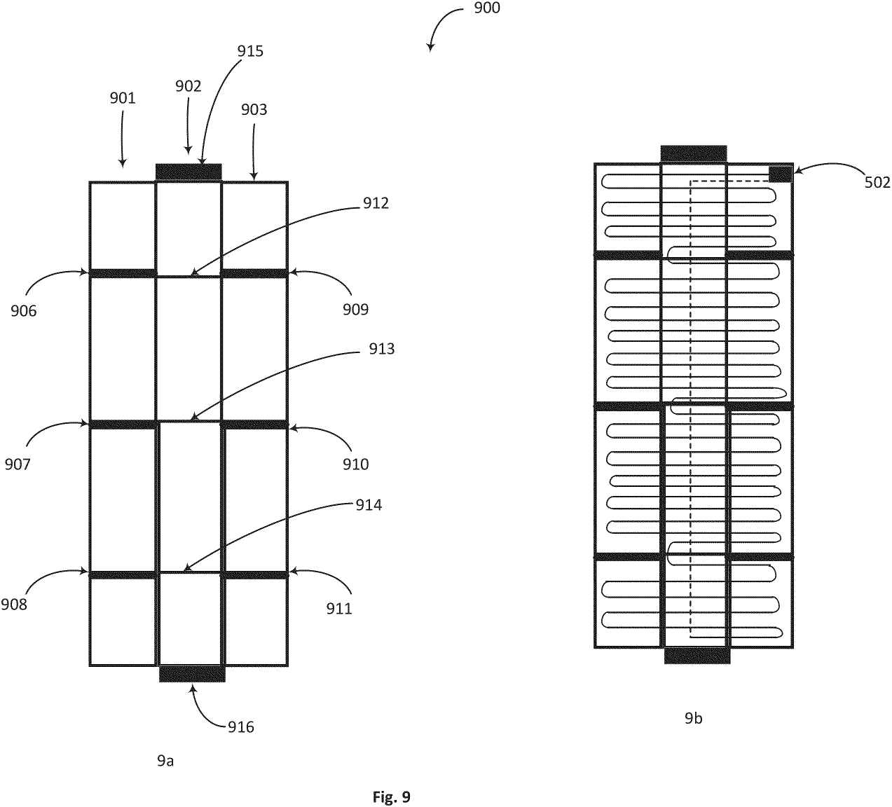

FIG. 9, 900 shows how to apply the security against tampering in this invention to a rectangular box as shown in FIG. 1b. These types of boxes are very common for the shipping industry especially for items ordered on the internet. To manufacture these boxes the process starts with an open layer of cardboard as shown in FIG. 9b. In Figure 900a, the cardboard base material has three vertical sections, 901, 902, 903 that are parallel to each other. Section 901 has dividing cuts at 906, 907, 908 and vertical section 903 has three dividing cuts at 909, 910, 911. The vertical section 902 does not have any cuts, but it has folds in sections 912. 913, 914. When the box is formed, vertical sections 901 will be folded in the cuts until they are perpendicularly positioned with respect to all the folded sections in vertical section 902. Sections under vertical section 901 will form the bottom of the box and sections under vertical section 902 will form the sides of the box. Once these sections are folded a wide piece of tape is applied to the bottom of the box the keep all the folded sections under vertical section 901 together forming the box. The two end tabs at 915 and 916 are joined with adhesive. This last step completes the box.

Thereafter, once the box is formed the shipping goods are placed in the box and afterwards the sections under vertical section 903 are folded at 909, 910, 911 to cover the box, and a wide piece of tape is applied to the top of the box.

FIG. 9b is an example of how the wire used to prevent tampering is applied to the box before the box is folded, and the electronics monitoring unit 502 is connected to the wire as shown. The wire, printed ink, or fiber optic material used to prevent tampering can be laid out as dense as necessary. In the illustration of FIG. 9b the wire is shown in a way that the cuts corresponding to FIG. 9a in sections 906, 907, 908, 909, 910, 911 are bypassed. Also, the wire is returned to the electronic monitoring unit 500 as shown by the dotted line (the wire has a thin layer of insulation, so the overlay does not affect the solution). A second layer of paper can be applied to the base cardboard to embed the wire used to protect from tampering. With this configuration it is not possible to access the interior of the box from all sides after the goods are in place and the box is put together. There are two exceptions to this, and that is the top and the bottom sections where the tape is placed. To protect these two areas, it is possible to use commercially available tamper evident security tape. Another alternative researched in our lab is to use the fringing capacitance between the two sides of the top and bottom flaps used to cover the lid and the bottom of the box and use sensors to determine a change in fringing capacitance to determine if the flaps were ever opened.

### General Interpretive Principles for the Present Disclosure

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, a system or an apparatus may be implemented, or a method may be practiced using any one or more of the aspects set forth herein. In addition, the scope of the disclosure is intended to cover such a system, apparatus or method which is practiced using other structure, functionality, or structure and functionality in addition to or other than the various aspects of the disclosure set forth herein. It should be understood that any aspect disclosed herein may be set forth in one or more elements of a claim. Although some benefits and advantages of the preferred aspects are mentioned, the scope of the disclosure is not intended to be limited to particular benefits, uses, or objectives. The detailed description and drawings are merely illustrative of the disclosure rather than limiting, the scope of the disclosure being defined by the appended claims and equivalents thereof.

With respect to the use of plural vs. singular terms herein, those having skill in the art can translate from the plural to the singular and/or from the singular to the plural as is appropriate to the context and/or application. The various singular/plural permutations may be expressly set forth herein for sake of clarity.

When describing an absolute value of a characteristic or property of a thing or act described herein, the terms “substantial,” “substantially,” “essentially,” “approximately,” and/or other terms or phrases of degree may be used without the specific recitation of a numerical range. When applied to a characteristic or property of a thing or act described herein, these terms refer to a range of the characteristic or property that is consistent with providing a desired function associated with that characteristic or property.

In those cases where a single numerical value is given for a characteristic or property, it is intended to be interpreted as at least covering deviations of that value within one significant digit of the numerical value given.

If a numerical value or range of numerical values is provided to define a characteristic or property of a thing or act described herein, whether or not the value or range is qualified with a term of degree, a specific method of measuring the characteristic or property may be defined herein as well. In the event no specific method of measuring the characteristic or property is defined herein, and there are different generally accepted methods of measurement for the characteristic or property, then the measurement method should be interpreted as the method of measurement that would most likely be adopted by one of ordinary skill in the art given the description and context of the characteristic or property. In the further event there is more than one method of measurement that is equally likely to be adopted by one of ordinary skill in the art to measure the characteristic or property, the value or range of values should be interpreted as being met regardless of which method of measurement is chosen.

It will be understood by those within the art that terms used herein, and especially in the appended claims (e.g., bodies of the appended claims) are intended as “open” terms unless specifically indicated otherwise (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

In those instances where a convention analogous to “at least one of A, B, and C” is used, such a construction would include systems that have A alone, B alone, C alone, A and B together without C, A and C together without B, B and C together without A, as well as A, B, and C together. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B″ will be understood to include A without B, B without A, as well as A and B together.”

Various modifications to the implementations described in this disclosure can be readily apparent to those skilled in the art, and generic principles defined herein can be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

What is claimed is:

1. A shipping container comprising:
a container body comprising one or more layers;
at least one sensor embedded within at least one of the one or more layers or positioned between at least two of the one or more layers; and
monitoring electronics connected to the sensor, wherein the monitoring electronics is configured to detect a tampering status of the container based at least in part on a signal from the sensor.

2. The shipping container of claim 1, wherein at least one of the one or more layers comprises a first material, and wherein the at least one sensor comprises at least one second different material.

3. The shipping container of claim 1, wherein the first material comprises paperboard.

4. The shipping container of claim 1, wherein at least a first portion of the at least one sensor is positioned between two layers of paperboard.

5. The shipping container of claim 3, wherein the second material is electrically conductive.

6. The shipping container of claim 1, wherein the monitoring electronics comprises a transmitter configured to communicate status to a remote monitoring facility.

7. The shipping container of claim 1, wherein the monitoring electronics comprises one or more environmental sensors.

8. The shipping container of claim 1, wherein the body comprises an opening covered with a removable cap.

9. The shipping container of claim 8, wherein the monitoring electronics are associated with the removable cap.

10. The shipping container of claim 9, wherein the body and the removable cap each comprise electrical contacts configured to mate with one another.

11. The shipping container of claim 2, wherein second material comprises conductive ink.

12. A method for securing a shipping container, the method comprising:
placing goods into the container;
placing a removable cap onto the container;
wherein the placing connects monitoring electronics associated with the cap with at least one sensor associated with the container.

13. The method of claim 12, comprising initializing the monitoring electronics.

14. The method of claim 12, comprising using a security algorithm to associate a security access key with the container;
sending the security access key to a server; and
sending the security access key to the to a receiver of the goods.

15. The method of claim 12, wherein the monitoring electronics sends status information as a remote client to a server in a cloud computing environment.

16. The method of claim 12, wherein a status of the at least one sensor and/or the monitoring electronics is communicated to a personal communications tool used by a receiver of the goods.

17. A shipping container comprising a container body and a removable container cap, wherein the container body comprises a container wall comprising at least one sensor, wherein the container cap comprises monitoring electronics, and wherein the monitoring electronics are coupled to the at least one sensor when the container cap is coupled to the container body.

18. The shipping container of claim 17, wherein the container wall comprises a first material, and wherein the at least one sensor comprises at least one second different material.

19. The shipping container of claim 18, wherein the first material comprises paperboard.

20. The shipping container of claim 17, wherein the body and the removable cap each comprise electrical contacts configured to mate with one another.
